(19) United States
(12) Patent Application Publication
(10) Pub. No.: US 2008/0148631 A1
(43) Pub. Date: Jun. 26, 2008

(54) Apparatus and Method For Desert Environmental Control And For Promoting Desert Plants Growth

(76) Inventor: You-bao WAN, Jia-Xing City (CN)

Correspondence Address: LAW OFFICES OF J.F. LEE, 17800 CASTLETON STREET, SUITE 383, CITY OF INDUSTRY, CA, 91748, US

(21) Appl. No.: 11/932,036

(22) Filed: Oct. 31, 2007

(30) Foreign Application Priority Data
Dec. 22, 2006 (CN) 200610155407.7

(51) Int. Cl. A01G 13/02

(52) U.S. Cl. 47/22.1; 47/20.1; 47/32.3

(57) ABSTRACT

A method of desert environmental control using the apparatus as disclosed herein that can be installed in huge expanse of desert area, evenly spaced in a square matrix type formation, forming a protective layer against sunlight, and turning the sun's natural energy into electrical power by the solar panel or photo-voltaic cells that can be placed upon the shade panel as disclosed herein, creating a friendly environment that promotes plants growth and thus turning arid desert land into human friendly land at a cost lower than other current systems.

### FIELD AND BACKGROUND OF PRESENT INVENTION

Present invention relates to the method and apparatus thereof for promoting plants growth in desert environment, especially for cultivating plants on a mass scale in desert area, so as to prevent the desertization phenomenon faced in many inland regions and to alleviate the negative impact of green house effect. The implementation of desert environmental control is done by automatic electro-mechanical systems.

### OBJECT AND SUMMARY OF THE PRESENT INVENTION

Desertization, the process or evolution of land mass becoming dry, arid and barren, has been a major problem on a global scale, in light of the green house effect and the continued environment hazards brought about by human activities. It is estimated the desert land area, which takes up 17.58% of total land in China, is increasing at an annual rate of 2,460 square kilometers. In the border provinces, China is facing desertization expansion rate of more than 4%, severally impacting human and natural habitats in those areas.

One proposed way to fight desertization is by air dropping drought-resistant plant seeds, during rain season, hopefully the plants will grow quickly to alter the dry and arid condition of the desert. However, due to the hostile environment in the desert, such as the extreme temperature changes that fluctuate between day and night and the lack of water and nutrient, the effectiveness of such “green” effort was almost non-existent.

Human-aided forestation in desert area has also been attempted in many places. However, since the trees lack the requisite water and nutrient to counter the severe sun exposure and the violently destructive force by the constant sand dust storms, efforts in this regard were proven to be ineffective, at an estimated cost of billions of dollars.

Some local governments encourage people to move near or into desert areas and engage in some economic and agricultural activities, hoping that the civilization would turn the desert environment into a people-friendly environment. To date, all efforts are not successful.

An anti-desertization project was attempted, by planting square matrix of “fake trees”, which have an X-shape base and are inter-connected, creating a wind-blocking layer near ground surface and damping layer to stop sand dust being blown about. Such “fake tree” project, though achieving limited success for stopping encroachment of sand dust, failed to promote the ecological growth of plants and thus is not long-lasting and not cost-effective. Chinese patent application number 200122918.4 is an example in this regard.

Another desert environmental control, such as Chinese patent application 200410081493.2, provides for an apparatus with a transparent sealed structure, water-collecting mechanism and irrigation device. The transparent sealed structure keeps the water from evaporating and is used to inject into local and limited land area, creating a small oasis-like environment that is plant-friendly. However, such system is expensive and can only be used in small area, such as the oasis discussed. The plants growing in this type of system face would great difficulty for survival in the open environment after the time when the apparatus and associated devices are removed, leaving the plants to grow on their own. As a result, the mechanism is ill-suited for huge expanse of desert environment.

The negative impact of increased average atmospheric temperature brought about by greenhouse effect has attracted lot of attention today. Various proposals are put forth, including launching small disk-like objects to orbit around the earth, to block sun heat and therefore to restrain the increase of average atmospheric temperature. However, this proposal is costly and raises too many negative concerns that receive no agreement from the scientist community whether the implementation would be more beneficial or detrimental to mankind.

Some took lessons from the nature's offerings, such as the eruption of volcano and the ensuing dust covering a huge swath of sky, absorbing the sunshine and reducing the air temperature. A case in point is Mount Pinatubo of Philippines that erupted 1991, producing more than 5 billion cubic meters of ash and pyroclastic debris that effectively blocking the sun light coming down to earth and the earth temperature was decreased as a result. From this inspiration, some scientists, some with Nobel laureate, proposed to blast off huge amount of particles into atmosphere, forming a sun-absorbing layer, resulting in the reduction of sunshine intensity and atmospheric temperature. Such proposal, however, is susceptible that it would bring negative effect to the environment we are living in and is thus not a working solution.

In California, a company even attempted injecting mass amount of iron powder (about 50 tons) to the Pacific Ocean, to facilitate the reproduction of sea weed, algae and planktons in the ocean, in the hope these creatures will absorb the excessive CO₂ being released. Later follow-up examination of the project shows potential ecological dangers, such as the pollution of sea water.

None of the above actual and proposed methods/mechanisms produce promising result to control the desertization danger faced by many countries. Neither would any of the proposed methods work efficiently to alleviate the impact of greenhouse effect.

As such, present invention also discloses a method of reducing the negative consequences of greenhouse effect by massive planting of trees in desert area, by having the method of desert control disclosed herein. Present invention is also helpful in curbing the increase of average atmospheric temperature.

Present invention takes into consideration of the fact that desert areas are rich in the element of silicon, which is the second-most redundant element in the Earth crust and can be obtained by refining sand and removing the impurities to create photo-voltaic cells for power generation, a key consideration of present invention that facilitates the use of such photo-voltaic silicon cells.

The substance and method of present invention thus utilizes the resources that are local in nature (abundance of silicon in sand for producing solar cells and the abundance of solar energy) to efficiently achieve the purpose of desert environmental control.

### BRIEF DESCRIPTION OF THE DRAWINGS

FIG. 1 shows the structure of present invention as can be used in a desert area, to promote the growth of desert plants and for desert environmental control.

### DETAILED DESCRIPTION OF PREFERRED EMBODIMENTS

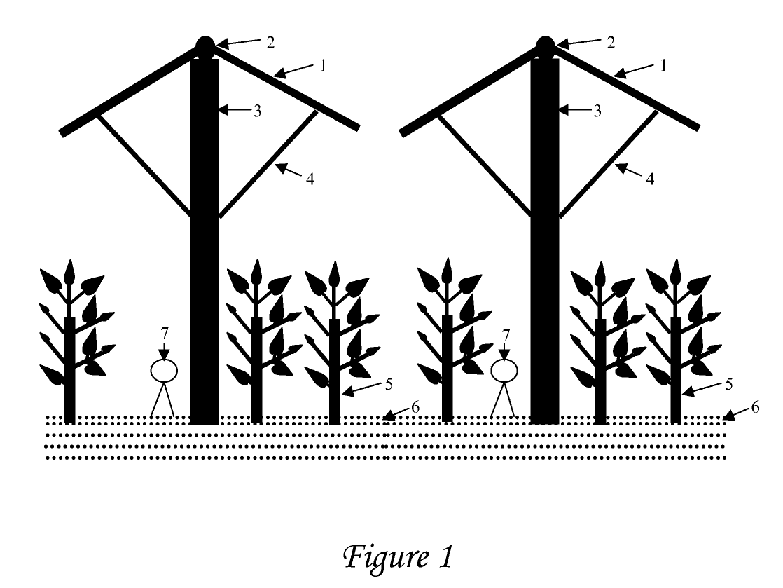

Referring to FIG. 1 of the drawing.

The desert plant growth promotion apparatus is made up of a plurality of umbrella-like structure each of which has a main support body 3, a pivoting rod holder 2 on top of said main support body 3, shade panel 1 and connecting rod 4.

Desert area is designated as number 6. Trees and (maintenance) people are designated as 5 and 7 respectively.

Connecting rod 4 has a first end having slidable means for attaching to mid-height of main support body 3 and a second end hinged to the under side of shade panel 2. That way, Connecting rod 4 can prop “open” shade panel 1 when the slidable means is locked at mid-height position and said connecting rod 4 can “close” said shade panel 1 when the slidable means falls to its lowest point along the vertical length of said main support body 3.

Connecting rod 4 has an ideal length of about 3 to 7 meters. Said connecting rod 4 can be control by automatic means of actuation so that shade panel 1 will be open during daylight hours, reducing evaporation of water from the ground, and shade panel 1 will be closed during night time hours, allowing moisture and the occasional rain water to reach down to the ground.

Said shade panel 1 can be opened, via control effectuated by control means of actuation stated above, at different angles, depending on the temperature/heat levels of the day, and the intensity of sunshine.

Pivoting rod holder 2 maintains the top end of shade panel 1 and allows some pivoting and rotational movements relative to main support body 3.

Main support body 3 can be made from concrete, steel bar embedded into concrete material, or pure steel/alloy material, so that it has the necessary strength to carry the weight of shade panels 1, which are made of rigid material capable of carrying solar panel or other photo-voltaic cells to generate the electrical power coming from sun light. A wind-driven electric-generating device can also be installed on top of the main support body 3, efficiently reducing the ill-effect of wind gusts in desert area, as a result of translating the energy of wind gustiness into “green” electric energy.

In addition, shade panel 1 of present invention shall have a transparent protective layer coated over the solar or photo-voltaic cells. As discussed, present invention takes into the natural richness of sand that is the source of silicon wafers for making photo-voltaic cells that will be placed on top of shade panels 1 to general electrical power.

Along the side of main support body 3, ladder or other climbing means shall be built, to enable maintenance access for people to go up and down.

By utilization of the structure disclosed herein, present invention also disclosed a method for desert control and management, to prevent over heating by sun light and reduce the sand dust over spreading carried by air currents, enabling desert plants to grow better and more efficiently, resulting in the reduction of desertization that is plaguing many regions today.

To achieve this, construct main support body 3 to average height of eight meters and erect a plurality of main support bodies 3 in a square matrix formation, having four meters as the distance in between every two main support bodies 3, in both horizontal and vertical directions.

The actual height of main support body 3 can vary from 5 to 15 meters, depending on the variables each construction project faces, and the sizes of other corresponding parts, such as the shade panel 1 and connecting rod 4.

Likewise, the square matrix formation can have the distance (longitudinal and latitudinal, not diagonal) between every two main support body 3 ranging from 4 to 12 meters.

Said shade panels 1 shall have an ideal size between 4 by 2.5 meters and 10 by 8 meters, which will be decided by respective construction project to fit local needs. Appropriate size, among the range stated herein, will be decided for best effect of blocking sun light and spreading dust from sand storms. The top side can be easily configured into installation of solar panels or photo-voltaic cells of different variety, which technology is not part of the disclosure of present invention is not claimed herein other than the specific implementation pertaining to the structure of present invention.

Present invention also discloses a method of reducing the negative consequences of greenhouse effect by massive planting of trees in desert area, by having the method of desert control disclosed herein.

What is claimed is:

1. An apparatus for promoting desert plants growth, comprising:
A vertical main support body;
A pivoting rod holder on top of said main support body;
A plurality of shade panels; and,
A plurality of connecting rods where a first end of said rod slidably attaches to mid-section of said main support body and a second end of said rod attaches to under side of said shade panel.

2. The apparatus of claim 1, wherein top end of said shade panel is secured to said pivoting rod holder, allowing pivoting and rotating movement.

3. The apparatus of claim 2, wherein an electric-mechanical control means is used to move the first end of said connecting rod up/down the main support body, resulting in the desired open or close position of present apparatus, so that said shade panels can be set to open automatically during day time and set to close during night time.

4. The apparatus of claim 3, wherein the material for main support body can be concrete, steel bar embedded into concrete material, or pure steel/alloy material.

5. The apparatus of claim 4, wherein the height of main support body is about 5 to 15 meters, the length of connecting rod is about 3-7 meters, and the size of shade panel ranges from about 4 by 2.5 meters to 10 by 8 meters.

6. The apparatus of claim 5, further comprising ladder or climbing means to allow maintenance access going up and down.

7. The apparatus of claim 6, wherein said shade panel contains solar or photo-electronic cells to convert sun energy into electrical power and further having a layer of transparent protective layer on top of said cells.

8. A method of desert environment control comprising a sun-blocking layer which offers an environment fit for the growth of plants and vegetations based upon above-claimed apparatus wherein a selected area is installed with a plurality of said devices in a square matrix formation having longitudinal and latitudinal distance of about 4-12 meters between every two of said apparatus, resulting in the reduction of sand storm and moisture dissipating.

9. A method to reduce the negative consequences of greenhouse effect consists of massive planting of trees having the aid of environment control method of claim 8.
